(19) United States
(12) Patent Application Publication
(10) Pub. No.: US 2005/0120888 A1
(43) Pub. Date: Jun. 9, 2005

(54) Multi-function breadmaker

(76) Inventor: Donglei Wang, Zhuhai City (CN)

Correspondence Address: CARSTENS YEE & CAHOON, LLP, P O BOX 802334, DALLAS, TX, 75380, US

(21) Appl. No.: 10/970,086

(22) Filed: Oct. 21, 2004

(30) Foreign Application Priority Data
Dec. 9, 2003 (CN) 2003201189569

(51) Int. Cl. A23L 1/00

(52) U.S. Cl. 99/348

(57) ABSTRACT

This invention discloses a multi-function breadmaker comprising: a housing, a base plate, an oven chamber, an electric heater, pan assemblies, a control assembly, an electric motor, a transmission assembly and multiple driving shafts; said base plate is installed at the bottom within the housing, said oven chamber and electric motor are both installed on the base plate, said transmission assembly is installed below the base plate; said multiple driving shafts, passing through the base plate, are installed at the bottom of the oven chamber, and driven simultaneously by the electric motor; characterized in that, there are at least two sets of pan assemblies, each set includes pans of different number and different size; each pan assembly includes a pan, a pan base and at least one kneading bar; each set of pan assemblies is interchangeable with another set, and can be installed on the bottom of said oven chamber, the kneading bar of each pan assembly engaging with corresponding driving shaft can be driven by said driving shaft; said control assembly includes software, whereby said breadmaker can work in different modes with corresponding set of pan assemblies loaded.

### TECHNICAL FIELD

This invention relates to a multi-function breadmaker, and more particularly, to a breadmaker which can work in different modes.

### BACKGROUND OF THE INVENTION

The conventional breadmaker works in single mode, either in single-pan mode, wherein the breadmaker is loaded with a single big pan (2.0 lb or 2.5 lb), or in two-pan mode, wherein the breadmaker is loaded with two small pans (1.0 lb). For example, the U.S. Pat. No. 6,113,966 entitled “Rapid Cycle Breadmaker” disclosed a breadmaker which has a single pan with two kneading bars, and only one loaf can be produced each time. While the Chinese patent No.99238752.3 entitled “A New Type of Breadmaker with Two Pans” disclosed a breadmaker which has two pan assemblies, each pan assembly including a top cover, a pan and a kneading bar. Said two pan assemblies are driven by one motor simultaneously via the transmission system. Since each pan can be loaded with different bread ingredients, the breadmaker can produce two loaves of bread with different flavor at one time. However, these two kinds of breadmaker can work in only one mode, and can not satisfy the various demands of the consumers.

### SUMMARY OF THE INVENTION

The main object of the present invention is to provide a multi-function breadmaker which can either work in single-pan mode or multiple-pan mode, so that the users can make bread of different size and different flavor by choosing different modes.
The breadmaker according to the present invention comprises:
a housing,
an electric motor,
an oven chamber,
an electric heater, wherein, said electric heater is located at the bottom within the oven chamber;
a transmission assembly,
a base plate, wherein, said base plate is installed at the bottom within the housing, said oven chamber and electric motor are both installed on the base plate, said transmission assembly is installed below the base plate;
multiple driving shafts, wherein, said multiple driving shafts, passing through the base plate, are installed at the bottom of the oven chamber, and driven simultaneously by said electric motor;
at least two sets of pan assemblies, each set includes pans of different number and different size; each pan assembly includes a pan, a pan base and at least one kneading bar; each set of pan assemblies is interchangeable with another set, and can be installed on the bottom within said oven chamber, the kneading bar of each pan assembly, engaging with corresponding driving shaft, can be driven by said driving shaft; and
a control assembly, wherein, said control assembly includes software, whereby said breadmaker can work in different modes with corresponding set of pan assemblies loaded.

Said multi-function breadmaker can be either a top load breadmaker or a side load breadmaker.

Said multiple sets of pan assemblies include one set of single big pan assembly and at least one set of multiple smaller pan assemblies. Said single big pan assembly has multiple kneading bars, said multiple kneading bars are of the same quantity as said multiple driving shafts, and said multiple kneading bars are so positioned that they are engaged with corresponding driving shafts.

Since said breadmaker has multiple sets of pan assemblies which are interchangeable and are of different size, and said breadmaker can work in different modes corresponding to different set of pan assemblies, compared with conventional breadmaker, the breadmaker of the present invention has following advantages:

1. Multiple Options for Bread of Different Shapes and Flavors

Since different pan assemblies can be loaded in the same breadmaker, more options are available for users. Bread of different size, shape and flavor can be produced with the same breadmaker, which provides more choices for the consumers and is more popular in market.

2. Simple Structure and Improved Performance-Cost Ratio

Since different sets of pan assemblies can be loaded in the same breadmaker, while only one set of base plate, transmission assembly and electric motor is needed, one breadmaker will have the same functions as several conventional breadmakers with less components required. Therefore, the performance-cost ratio of said breadmaker is improved.

### BRIEF DESCRIPTION OF THE DRAWINGS

FIG. 1 is a schematic view of the present invention with a single pan assembly loaded;

FIG. 2 is a schematic view of the present invention with two pan assemblies loaded;

FIG. 3 is a schematic view showing the transmission assembly of the present invention without any pan assembly loaded.

### DETAILED DESCRIPTION OF THE PREFERRED EMBODIMENTS

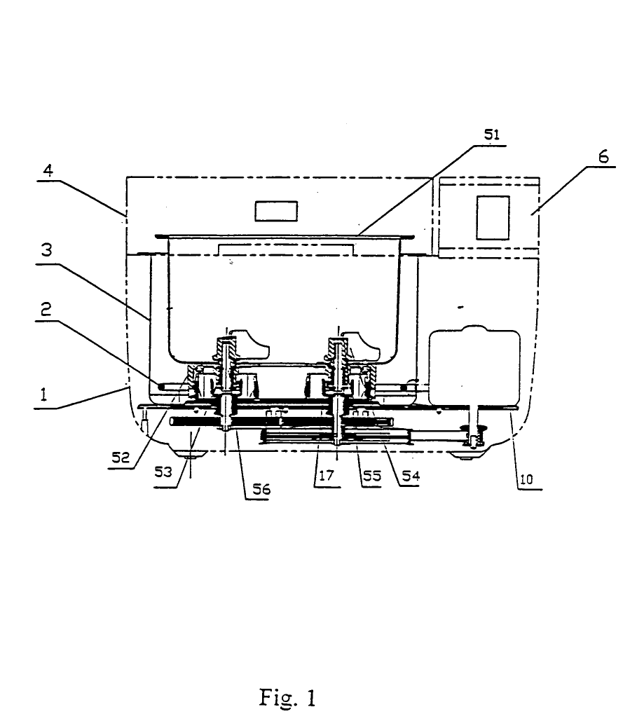

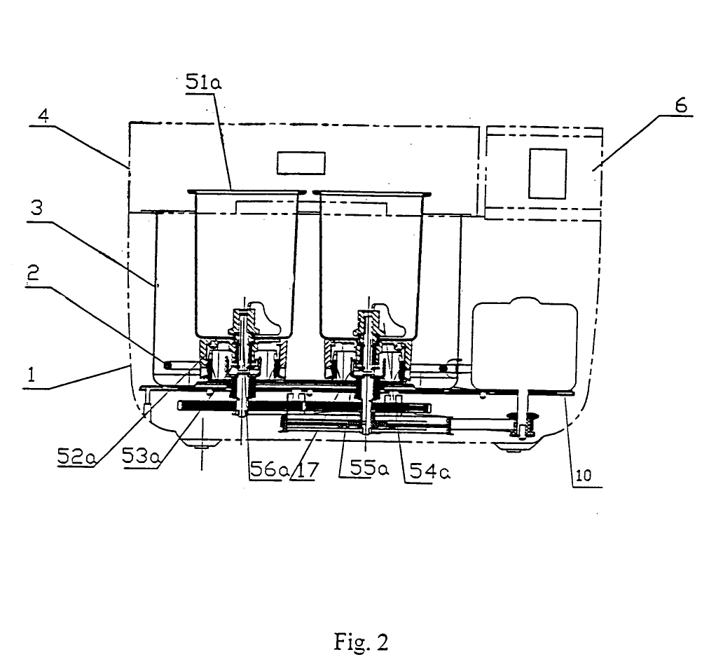

As shown in FIGS. 1, 2 and 3, in a preferred embodiment, the breadmaker comprises a housing 1, an electric heater 2, an oven chamber 3, a top cover assembly 4, a base plate 10, a control assembly 6, an electric motor 9, a transmission assembly, two driving shafts 71, 72, and two sets of pan assemblies.

The housing 1 is for accommodating and protecting the internal parts. The base plate 10 is located at the bottom within the housing 1, the oven chamber 3 and electric motor 9 are both located on the base plate 10, the transmission assembly is located below the base plate 10. Two driving shafts 71, 72 passing through the base plate 10 are installed at the bottom of the oven chamber 3, and are driven simultaneously by the electric motor 9. The pan assemblies are installed within the oven chamber 3, the electric heater 2 inside the oven chamber 3 is located at the bottom and irradiates heat for breadmaking.

The pan assemblies are for accommodating flour, kneading and breadmaking. There are two sets of pan assemblies, which are interchangeable with each other. One set includes a single big pan assembly with two kneading bars, the other set includes two identical small pan assemblies with single kneading bar.

The single big pan assembly consists of a big pan 51, two kneading bars and a big pan base 52. The two kneading bars are so positioned that they can engage with the driving shafts at the bottom of the oven chamber 3. Each kneading bar includes a key 53, a kneading shaft 56, a sleeve 55 and a kneading vane 54. There are holes on the bottom of the pan 51 and on the pan base 52 for installing the two kneading shafts 56, one end of each kneading shaft 56 is installed at the bottom within the pan 51, the other end, passing through the bottom of the pan 51 and the big pan base 52, is engaged with the driving shaft at the bottom of the oven chamber 3. The sleeve 55 is blind on one end and open on the other end, the kneading vane 54 is secured at the sleeve 55. The key 53 is secured at the bottom of the kneading shaft 56. On the top of the driving shafts 71, 72 are provided with grooves 17 which are matching with the key 53, whereby the kneading shafts 56 are driven. The big pan 51, pan base 52, kneading shaft 56 and the key 53 can be pre-assembled, while the sleeve 55 and the kneading vane 54 can be either integrally pre-assembled with the previous parts, or be separated from the previous parts, and be easily connected to the kneading shaft 56 when using.

Each small pan assembly consists of a small pan 51a, a single kneading bar and a small pan base 52a. The single kneading bar includes a key 53a, a kneading shaft 56a, a sleeve 55a and a kneading vane 54a. The small pan assembly is similar to the big pan assembly, except that, each small pan assembly has an independent pan base 52a, and each small pan assembly has only a single kneading bar.

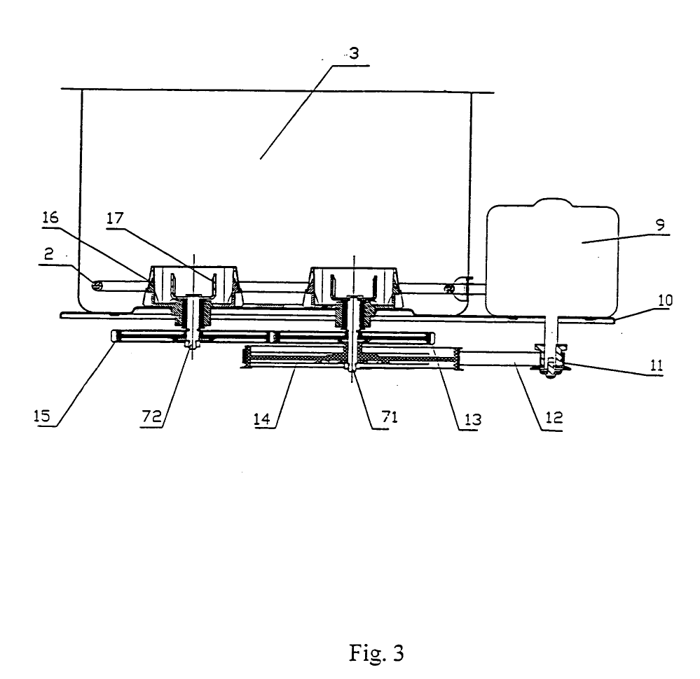

As shown in FIG. 3, the transmission assembly includes a belt 12, wheels 11, 14 and gears 13, 15. The driving shaft 71 is driven by electric motor 9 via the belt 12 and the wheels 11, 14, then, the driving shaft 72 is driven by the gear 13 and 15. On the driving shafts 71 and 72 are installed grooves 17, which are coupled with the keys secured on the kneading shaft, so that, the two kneading shafts are driven to rotate, and thereby, the two kneading bars are rotated in the big pan mode, or the two single kneading bars are rotated in the two small pan mode.

Said control assembly 6 includes control panel, circuit board and software. Said software contains instructions corresponding to different modes. By setting the proper menu at the control panel, the users can control the breadmaker to work in different modes.

The process for making a big loaf of bread is as follows: pour flour into the pan; load the big pan assembly into the oven chamber, get the big pan assembly engaged with the base plate and the kneading shafts, then close the top cover; set the menu at the control panel, then push the “start” button; a big loaf of bread will be produced automatically.

The process for making one or two small loaves of bread is as follows: pour the flour into the pan; load one or two of the small pan assemblies into the oven chamber, get the small pan assembly engaged with the base plate and the kneading shaft, then close the top cover; set the menu at the control panel, then push the “start” button; one or two small loaves of bread will be produced automatically.

By choosing the proper pan assembly, the users can make either one big loaf, or one small loaf, or two small loaves of bread for one time.

In addition to the above embodiment, there may be other options for the pan assemblies, such as:
(1) two sets: one set includes a single big pan assembly with three kneading bars, the other set includes three small pan assemblies, each small pan assembly having one kneading bar;
(2) three sets: one set includes a single big-size pan assembly with four kneading bars, another set includes two middle-size pan assemblies, each middle-size pan assembly having two kneading bars, the other set includes four small-size pan assemblies, each small-size pan assembly having one kneading bar;

While the invention has been particularly shown and described with reference to a preferred embodiment, it will be understood by those skilled in the art that various changes in form and detail may be made therein without departing from the spirit and scope of the invention.

1. A breadmaker comprises:
a housing,
an electric motor,
an oven chamber,
an electric heater, wherein, said electric heater is located at the bottom within the oven chamber;
a transmission assembly,
a base plate, wherein, said base plate is installed at the bottom within the housing, said oven chamber and electric motor are both installed on the base plate, said transmission assembly is installed below the base plate;
multiple driving shafts, wherein, said multiple driving shafts, passing through the base plate, are installed at the bottom of the oven chamber, and driven simultaneously by said electric motor;
at least two sets of pan assemblies, each set includes pans of different number and different size; each pan assembly includes a pan, a pan base and at least one kneading bar; each set of pan assemblies is interchangeable with another set, and can be installed on the bottom within said oven chamber, the kneading bar of each pan assembly, engaging with corresponding driving shaft, can be driven by said driving shaft; and
a control assembly, wherein, said control assembly includes software, whereby said breadmaker can work in different modes with corresponding set of pan assemblies loaded.

2. A multi-function breadmaker according to claim 1, wherein, said multiple sets of pan assemblies include one set of single big pan assembly and at least one set of multiple smaller pan assemblies; said single big pan assembly has multiple kneading bars, said multiple kneading bars are of the same quantity as said multiple driving shafts, and said multiple kneading bars are so positioned that they are engaged with corresponding driving shafts.

3. A multi-function breadmaker according to claim 2, wherein, there are two sets of pan assemblies, one set includes a single big pan assembly with two kneading bars, the other set includes two small pan assemblies, each small pan assembly having one kneading bar.

4. A multi-function breadmaker according to claim 3, wherein, said transmission assembly includes a belt 12, two wheels 11, 14 and two gears 13, 15; the first driving shaft 71 is driven by electric motor 9 via the belt 12 and the two wheels 11, 14, then, the second driving shaft 72 is driven by the two gears 13, 15; on the two driving shafts 71, 72 are installed grooves 17, which are coupled with the keys secured on the kneading shaft, so that, the two kneading shafts are driven to rotate, and thereby, the two kneading bars are rotated.

5. A multi-function breadmaker according to claim 2, wherein, there are two sets of pan assemblies, one set includes a single big pan assembly with three kneading bars, the other set includes three small pan assemblies, each small pan assembly having one kneading bar.

6. A multi-function breadmaker according to claim 2, wherein, there are three sets of pan assemblies, one set includes a single big-size pan assembly with four kneading bars, another set includes two middle-size pan assemblies, each middle-size pan assembly having two kneading bars, the other set includes four small-size pan assemblies, each small-size pan assembly having one kneading bar.

7. A multi-function breadmaker according to claim 1, wherein, each kneading bar includes a key 53, a kneading shaft 56, a sleeve 55 and a kneading vane 54; one end of each kneading shaft 56 is installed at the bottom of the pan 51, the other end, passing through the bottom of the pan 51 and the big pan base 52, is engaged with the driving shaft at the bottom of the oven chamber 3; the key 53 is secured at the bottom of the kneading shaft 56; on the top of the each of the driving shafts is provided with a groove which is matching with the key 53, whereby the kneading shafts 56 are driven.

8. A multi-function breadmaker according to claim 7, characterized in that, the big pan 51, pan base 52, kneading shaft 56, the key 53, the sleeve 55 and the kneading vane 54 are integrally pre-assembled.

9. A multi-function breadmaker according to claim 7, characterized in that, the big pan 51, pan base 52, kneading shaft 56 and the key 53 are pre-assembled, while the sleeve 55 and the kneading vane 54 are separated from the previous parts and can be connected to the kneading shaft 56 when using.
